(19) United States
(12) Patent Application Publication
(10) Pub. No.: US 2018/0167341 A1
(43) Pub. Date: Jun. 14, 2018

(54) AUTOMATED OUT-OF-OFFICE FUNCTIONALITY

(71) Applicant: Microsoft Technology Licensing, LLC, Redmond, WA (US)

(72) Inventor: Chandrashekar BS, Bangalore (IN)

(73) Assignee: Microsoft Technology Licensing, LLC, Redmond, WA (US)

(21) Appl. No.: 15/376,492

(22) Filed: Dec. 12, 2016

(51) Int. Cl. H04L 12/58; H04L 29/08; G06Q 10/10

(52) U.S. Cl. CPC H04L 51/02; G06Q 10/1095; H04L 67/10; H04L 51/04

(57) ABSTRACT

This document relates to automated out-of-office functionality. One example is a technique that includes identifying an out-of-office event that is scheduled to occur at a particular date. The technique also includes detecting that the out-of-office event has arrived. The technique also includes automatically activating out-of-office functionality on a computing device associated with a user, responsive to detecting that the out-of-office event has arrived.

### BACKGROUND

Email, instant messaging, electronic calendars, and other technologies are nearly always online. However, users of these technologies are not always available for communication, such as when the user is out of the office. In some cases, users may manually inform one another of their anticipated future availability.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to automated out-of-office processing. One example is a method or technique that can be performed by a computing device. The example method or technique includes identifying an out-of-office event that is scheduled to occur at a particular date. The example method or technique also includes detecting that the out-of-office event has arrived. The example method or technique also includes automatically activating out-of-office functionality on a computing device associated with a user, responsive to detecting that the out-of-office event has arrived.

Another example is a system that includes a processor and a computer-readable storage medium storing instructions. When the instructions are executed by the processor, the instructions can cause the processor to detect an out-of-office event for a user. The instructions can also cause the processor to automatically configure an out-of-office message for the user responsive to detecting the out-of-office event.

Another example is a computing device that includes a storage device and a processor. The storage device can store an email application and a file having programming statements. The processor can be configured to execute the email application and the programming statements. When executed by the processor, the programming statements can be configured to automatically detect out-of-office events. The programming statements can also be configured to cause the email application to send out-of-office messages indicating that a user of the email application is out-of-office for the duration of the out-of-office events.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIGS. 1, 5, and 6 illustrate exemplary systems that are consistent with some implementations of the present concepts.

FIGS. 2 illustrates an exemplary technique that is consistent with some implementations of the present concepts.

FIGS. 3 and 4 illustrate exemplary graphical user interfaces that are consistent with some implementations of the present concepts.

FIG. 7 illustrates an exemplary pseudocode algorithm that is consistent with some implementations of the present concepts.

### DETAILED DESCRIPTION

### Overview

In some cases, an application can provide out-of-office functionality for a user. For example, a user of an email application may be able to manually configure out-of-office messages to be sent for a particular period of time when the user anticipates being unavailable. As another example, a user of an electronic calendar may configure certain dates on the electronic calendar to indicate that they will be out-of-office on those dates. In the disclosed implementations, out-of-office messages can be automatically configured for a user. In further implementations, out-of-office messages can be automatically populated with information, such as the dates when the user will be unavailable.

### Single Device Scenario

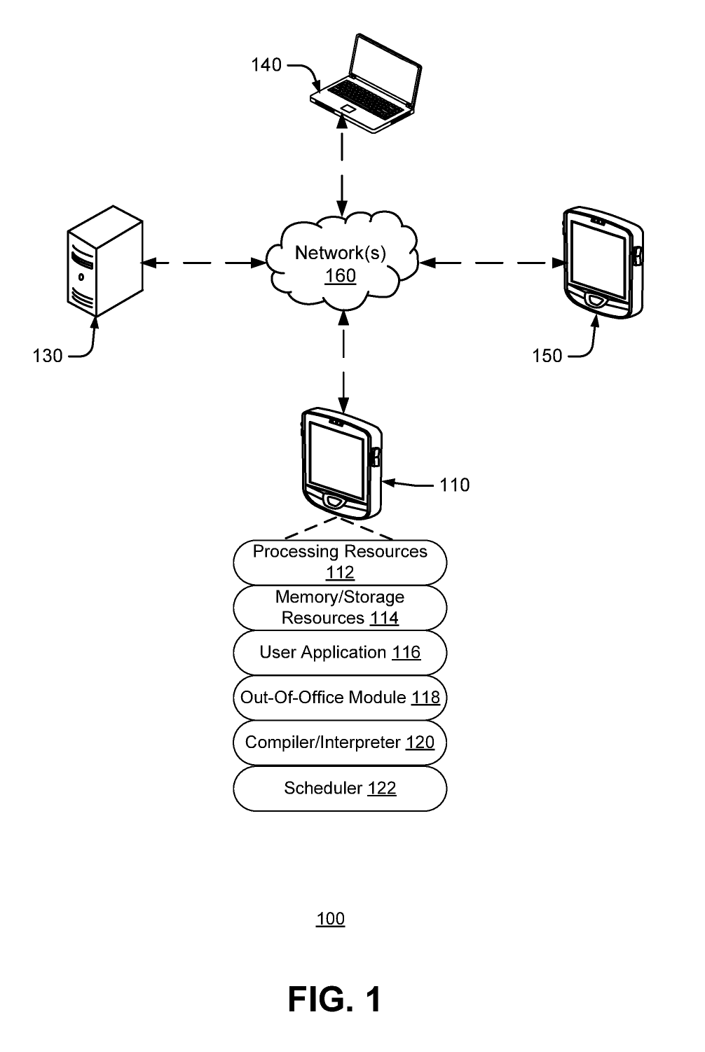

FIG. 1 shows an example system 100 in which the disclosed concepts can be performed. FIG. 1 shows an example where the disclosed techniques occur entirely or predominantly on a single user device 110. Subsequent examples will introduce cloud scenarios where similar techniques are performed by a cloud service and also where similar techniques are distributed across multiple user devices in a peer-to-peer system.

User device 110 can include processing resources 112, memory/storage resources 114, a user application 116, an out-of-office module 118, a compiler/interpreter 120, and a scheduler 122. Generally, the memory/storage resources can store computer-readable instructions and data. The computer-readable instructions can configure the processing resources to provide the user application, the out-of-office module, the compiler/interpreter, and the scheduler. In implementations where the compiler/interpreter is a compiler, the compiler may initially generate the out-of-office module as a stand-alone executable from data (e.g., a batch or text file with programming statements) and, subsequently, the stand-alone executable can be executed multiple times without re-compilation by the compiler. In implementations where the compiler/interpreter is an interpreter, the programming statements of the out-of-office module can be interpreted line-by-line by the interpreter each time the out-of-office module is invoked by the scheduler.

Generally, the user application 116 can provide functionality such as sending and receiving emails via server 130, e.g., to and from user devices 140 and/or 150. The scheduler 122 can periodically invoke the out-of-office module 118, such as every day at a particular time, every time the user logs off of user device 110, etc. When the out-of-office module is compiled as a stand-alone executable, the scheduler can directly invoke the executable at the predetermined times. When the out-of-office module is interpreted, the scheduler can invoke the interpreter 120, which can then interpret individual text statements in the out-of-office module and then execute the statements as they are interpreted. Whether compiled or interpreted, the out-of-office module can automatically configure the user application to perform out-of-office functionality when certain conditions are met, as discussed more below.

In some cases, the out-of-office module 118 can include logic to access a source of out-of-office data that identifies out-of-office events when the user is expected to be out of the office. For example, the user may work for an organization that provides out-of-office dates (e.g., holidays, weekends, etc.) to the user device 110. In some cases, these out-of-office dates can be hard-coded into the out-of-office module. In other cases, the dates can be deployed in a local file (e.g., a text file) on user device 110. In still further cases, the out-of-office module can be provided with a URL or other network location (e.g., network drive location) where a file with the holidays is stored, and can retrieve the out-of-office data over the network 160 initially or each time the out-of-office module is invoked.

### Example Method

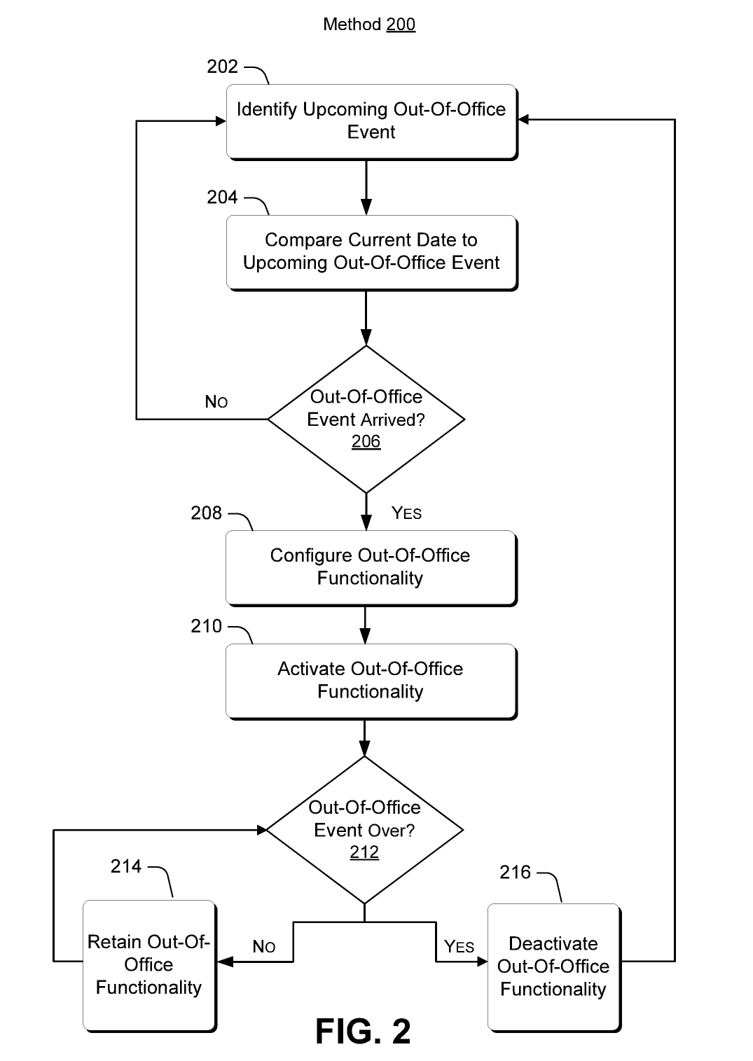

FIG. 2 illustrates an exemplary method 200 consistent with the present concepts. This method can be implemented on many different types of devices, e.g., by user device 110 as shown in FIG. 1, by one or more cloud servers as shown below, etc.

Method 200 begins at block 202, where an out-of-office event is identified. For example, out-of-office module 118 can retrieve a holiday schedule from local or remote storage, and identify the next upcoming holiday and a particular date when the upcoming holiday is scheduled to occur.

Next, at block 204, the current date is compared to the particular date when the out-of-office event is scheduled to occur. For example, a local clock on the computing device 110 can provide the current date. In other implementations, a network service can be contacted by the computing device to retrieve the current date.

Next, at block 206, the method detects whether the out-of-office event has arrived. For example, in some implementations, if it is later than a specified time (e.g., after regular business hours, say, at 5:30 PM) on the day before the out-of-office event begins, block 206 determines that the out-of-office event has arrived. If the out-of-office event is not deemed to have arrived, the method returns to block 202 and continues until out-of-office event arrives.

If the out-of-office event has arrived at block 206, the method moves to block 208, where out-of-office functionality is configured. For example, the out-of-office module 118 can call an application programming interface (“API”) of the user application 116. The call to the API may cause the user application to configure out-of-office functionality, such as populating an out-of-office message with a beginning time and/or an ending time of the out-of-office time period.

Next, at block 210, the out-of-office functionality is activated. For example, if the user application 116 provides email functionality, the out-of-office module 118 can configure the user application to send the out-of-office message to other users in response to received emails. As another example, if the user application provides calendar functionality, the out-of-office module can configure the user application to send the out-of-office message in response to received invitations to meetings that occur during the out-of-office time period. As a further example, if the user application provides chat functionality, the out-of-office module can designate the user as unavailable for chat and configure the chat functionality to send the out-of-office message in response to chat messages received during the out-of-office period.

Next, at block 212, the method makes another determination as to whether the out-of-office event is over. For example, the end time of the out-of-office event can be compared again to the current date. If the current date is not the last day of the out-of-office event and/or it is earlier than a specified time on the last day of the out-of-office event (e.g., 5:30 PM), then the out-of-office event is deemed to be still in effect. In this case, the method moves to block 214, where the out-of-office functionality is retained and the method returns to block 212 for further determinations. Note that blocks 208 and/or 210 can be performed in some implementations entirely without user input, e.g., the user's out-of-office functionality can be configured and activated for the user without the user explicitly indicating they intend to be out-of-office.

If the current date is the last day of the out-of-office event and it is later than the specified time, the out-of-office event is deemed to be over and the method moves to block 216. At block 216, the out-of-office functionality is deactivated. For example, the out-of-office module 118 can call another API that causes the user application 116 to stop sending the out-of-office message. At this point, the method can return to block 202 and continue with the next out-of-office event.

### Example Email Interfaces

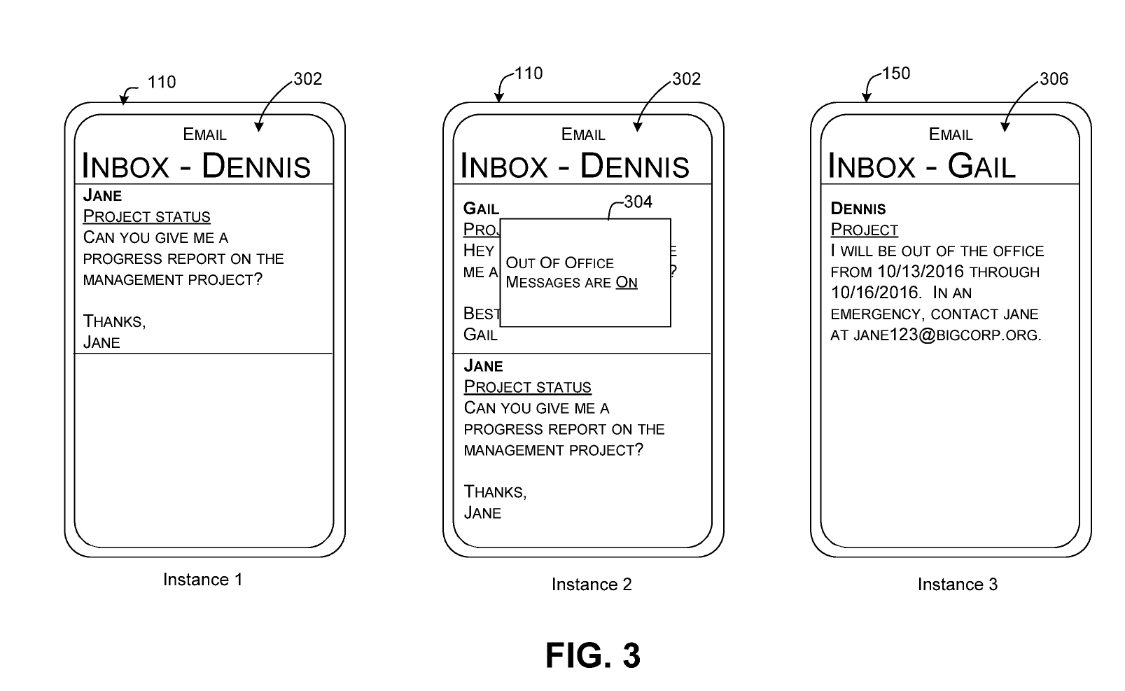

FIG. 3 illustrates an exemplary user experience that can occur using the disclosed implementations when the user application 116 provides email functionality. Instance 1 shows the user experience of a user named Dennis on user device 110 before the out-of-office functionality is activated. Here, Dennis can see his inbox 302 and an email from a colleague named Jane. Instance 2 show Dennis' user experience after the out-of-office functionality has been activated. For example, Dennis may see a pop-up message 304 indicating that out-of-office messages are now turned on. For example, Dennis may see the message at 5:30 PM on the evening before a holiday, after scheduler 122 activates the out-of-office module 118. Also, Dennis sees that he has received another email from his colleague Gail.

Instance 3 shows the user experience of Dennis' colleague Gail on user device 150, after sending Dennis a message after 5:30 PM. Here, Gail receives an automatic message from computing device 110 in her inbox 306 indicating that Dennis is out of the office from 10/13/2016 through 10/16/2016. Note also that the automatic message is automatically populated not only with the dates when Dennis will be out of the office, but also with emergency contact information for his colleague Jane.

### Example Calendar Interface

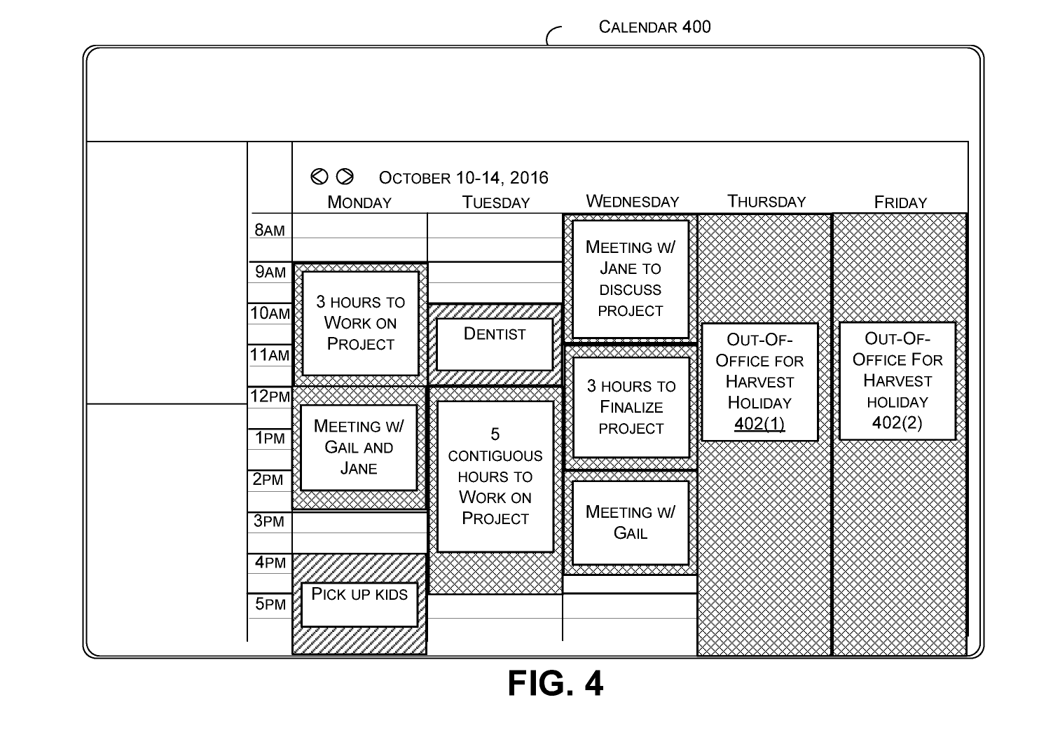

FIG. 4 illustrates an exemplary user experience that can occur using the disclosed implementations when the user application 116 provides calendar functionality. FIG. 4 shows a calendar 400, associated with Dennis, the user of user device 110. Calendar 400 can show various activities scheduled for Dennis during the week of Oct. 10-14, 2016. When the out-of-office module 118 activates out-of-office functionality for the user application, this can include scheduling out-of-office periods 402(1) and 402(2) for Dennis on calendar 400.

Note that calendar 400 can appear on user device 110 for Dennis as well as on other computing devices. For example, in some cases, calendar 400 may be shared with other users (e.g., Gail and/or Jane). Thus, Gail and/or Jane may be able to see Dennis' calendar on their own devices, e.g., user devices 140 and/or 150 as shown in FIG. 1.

### Cloud Scenario

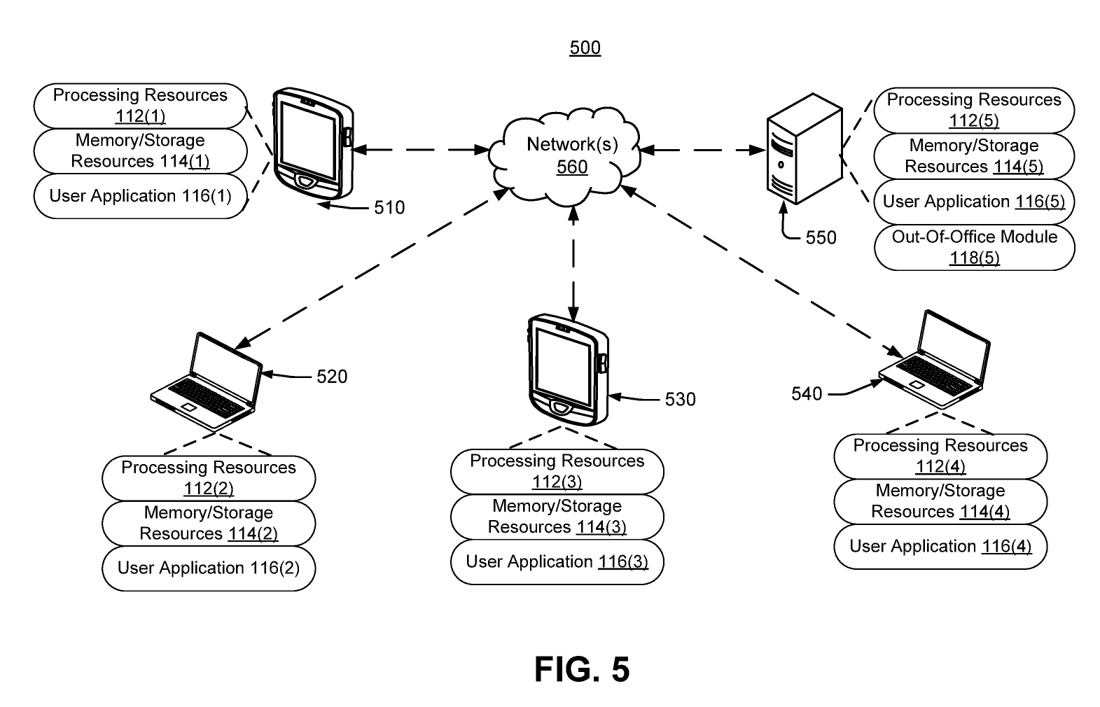

The disclosed implementations can be performed by a cloud service. FIG. 5 shows an example system 500 including various computing systems. These computing systems include user devices 510, 520, 530, and 540, as well as a cloud server 550. The user devices and cloud server are communicably connected via a network 560.

Certain components shown in FIG. 5 may be referred to herein by parenthetical reference numbers. For the purposes of the following description, parenthetical reference (1) identifies an instance of a given component on user device 510, (2) indicates an instance of a given component on user device 520, (3) indicates an instance on user device 530, (4) indicates an instance on user device 540, and (5) indicates an instance on cloud server 550. Unless identifying a specific instance of a given component, this document will refer generally to the components of the computing systems without the parenthetical. When referring to components such as those already introduced in FIG. 1, these components will carry over the same reference number as previously used in FIG. 1.

Generally, each of the user devices 510-540 and cloud server 550 may have respective processing resources 112 and memory/storage resources 114, which are discussed in more detail below. The user devices and cloud server may also have various modules that function using the processing and memory/storage resources to perform the techniques discussed herein, as discussed more below.

Each user device 510-540 and cloud server 550 can have an instance of user application 116. Additionally, out-of-office module 118(5) can be provided on the cloud server. For example, user application 116(5) on cloud server 550 can provide cloud application services, e.g., act as an email server, a shared calendar server, etc. User applications 116(1), 116(2), 116(3), and 116(4) can act as client-side components that interact with the cloud server. In this case, the out-of-office module 118(5) can configure one or more of the instances of user application 116 to perform out-of-office functionality.

For example, consider the case where user application 116(5) on cloud server 550 acts as an email server and user applications 116(1)-116(4) on user devices 510-540 act as email clients. Here, the out-of-office module 118(5) on the cloud server can cause the user application 116(5) on the cloud server to send out-of-office emails for one or more of the users in response to received emails. In some cases, this can be done without activating out-of-office functionality on the user applications 116(1)-116(4). For example, the cloud server 550 can send out-of-office messages on behalf of the users without involving the user applications on the user devices. In other cases, the out-of-office module 118(5) on the cloud server can communicate an instruction to one or more of the user applications on the user devices to send out-of-office messages in response to received emails. In this case, the out-of-office messages are initiated by the respective user devices instead of by the cloud server.

As another example, consider the case where user application 116(5) on cloud server 550 provides an electronic calendar service and user applications 116(1)-116(4) act as calendar clients. Here, the out-of-office module 118(5) on the cloud server can cause the user application 116(5) on the cloud server to send out-of-office messages for one or more of the users in response to invitations that occur during an out-of-office event. In some cases, this can be done without activating out-of-office functionality on the user devices 510, 520, 530, and 540 as mentioned above, e.g., by the cloud server 550 sending out the out-of-office messages on behalf of the respective users. In other cases, the out-of-office module on the cloud server can communicate an instruction to one or more of the user devices to send out-of-office messages in response to invitations that occur during an out-of-office event.

### Peer-to-Peer Scenario

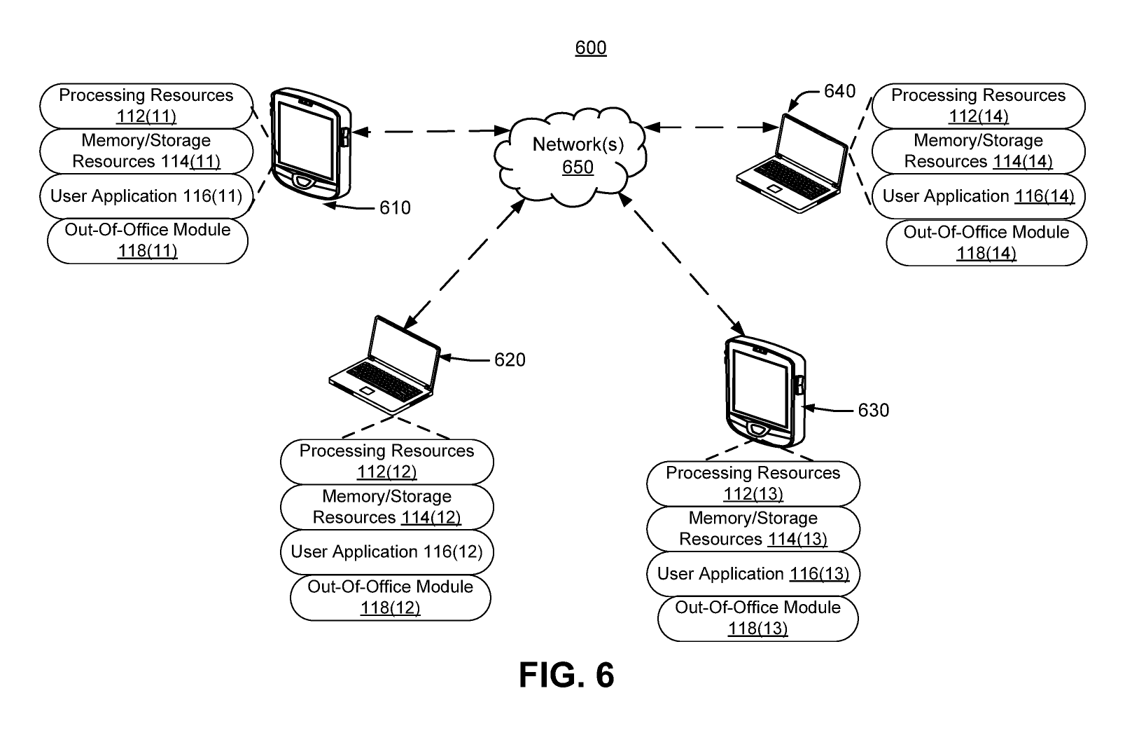

The disclosed implementations can be performed in a peer-to-peer system. FIG. 6 shows an example system 600 including various computing systems. These computing systems include peer devices 610, 620, 630, and 640. The user devices and cloud server are communicably connected via a network 650.

Certain components shown in FIG. 6 may be referred to herein by parenthetical reference numbers in a manner similar to that discussed above with respect to FIG. 5. For the purposes of the following description, parenthetical reference (11) identifies an instance of a given component on peer device 610, (12) indicates an instance of a given component on peer device 620, (13) indicates an instance on peer device 630, and (14) indicates an instance on peer device 640. Unless identifying a specific instance of a given component, the following description will refer generally to the components of the peer devices without the parenthetical. When referring to components such as those already introduced in FIG. 1 and/or FIG. 5, these components will carry over the same reference number as previously used in FIG. 1 and FIG. 5.

Generally, each of the peer devices 610-640 may have respective processing resources 112 and memory/storage resources 114, which are discussed in more detail below. The various peer devices may also have various modules that function using the processing and memory/storage resources to perform the techniques discussed herein, as discussed more below.

Each peer device in system 600 can have an instance of a user application 116 and out-of-office module 118. As discussed above, the user application can provide messaging functionality (e.g., email, chat, etc.), calendar and/or scheduling functionality, etc. In the peer-to-peer scenarios discussed herein, each peer device generally communicates messages, calendar updates, and other information to other peers by using intermediary peers to perform communication instead of using a centralized server as discussed with respect to FIG. 5.

For example, consider the case where the user of peer device 610 composes and sends an email message to the user of peer device 640. Peer device 610 may be a neighbor of peer device 620 in a peer-to-peer overlay, but not a neighbor of peer devices 630 and/or 640. Thus, to send the email message to peer device 640, peer device may send the message to peer device 620 instead. Peer device 620 may be a neighbor of peer device 630 in the overlay, but not a neighbor of peer device 640. Thus, peer device 620 may forward the email message to peer device 630. Peer device 630 may be a neighbor of peer device 640 in the overlay, and thus peer device 630 may send the email message to peer device 640.

Out-of-office modules 118(11), 118(12), 118(13), and 118(14) may implement out-of-office functionality in system 600 in various ways. For example, if the user of peer device 610 will be out-of-office, then in some cases the out-of-office module 118(11) on peer device 610 can activate out-of-office functionality. In this case, the out-of-office module 118(11) can cause out-of-office messages to be sent through the peer-to-peer system in a manner similar to that discussed above, e.g., through peer device 620, on to peer device 630, and finally to peer device 640.

In further implementations, the out-of-office module 118 that activates the out-of-office functionality does not necessarily reside on the peer device of the user that will be out-of-office. For example, if the user of peer device 610 is out-of-office, out-of-office module 116(13) on peer device 630 may detect this. Next, the user of peer device 640 may attempt to send an email message to the user of peer device 610. Instead of forwarding the message along to peer device 610, out-of-office module 118(13) on peer device 630 may instead send an out-of-office message back to peer device 640 on behalf of the user of peer device 610. By doing so, peer device 630 can reduce network traffic/bandwidth use by reducing the number of network communications for sending the out-of-office message relative to scenarios where the peer device 610 receives the email message and responds with the out-of-office message.

### Example Algorithm

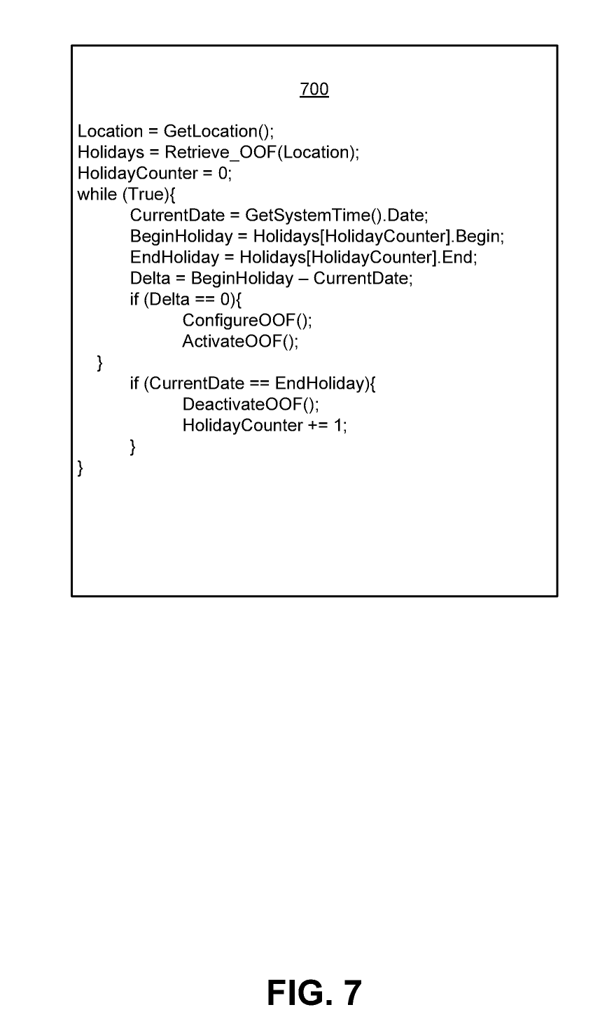

FIG. 7 illustrates an exemplary pseudocode algorithm 700 that can be performed by the out-of-office module 118. First, the pseudocode algorithm obtains the current location of a user's device by calling a GetLocation( ) function and populating a variable named Location. Next, the variable named Location is used to obtain a list of holidays for the user's location by calling a Retrieve_OOF( ) function and populating a variable named Holidays. For example, assume the user is located in a country that has a Harvest Festival beginning on Thursday, Oct. 13, 2016 and extending through Sunday, Oct. 16, 2016.

Next, the pseudocode algorithm 700 sets a variable named HolidayCounter to 0. Generally, the pseudocode algorithm uses the HolidayCounter to track the next holiday in the Holidays variable. For example, the Holidays variable may be an array or list of holidays that can be indexed using HolidayCounter.

Next, the pseudocode algorithm 700 enters a while (True) loop. For each iteration of the loop, the pseudocode algorithm sets a variable named CurrentDate to the system time by calling a function named GetSystemTime.Date( ). In some cases, the date that is returned by the function can be a Julian date (e.g., a number between 0 and 365).

Next, the pseudocode algorithm 700 sets a variable named BeginHoliday to the first date of the current holiday, as determined by indexing into the Holidays variable with the HolidayCounter. Likewise, the pseudocode algorithm sets a variable named EndHoliday to the last day of the holiday. In this example, BeginHoliday can have a Julian date of 286 and EndHoliday can have a Julian date of 289.

Next, the pseudocode algorithm 700 sets a variable named Delta set to the difference of BeginHoliday (286, in this example) and CurrentDate. On Tuesday, October 11, the Julian date is 284, so Delta is 2. On Wednesday, October 12, the Julian date is 285, so Delta is 1. On Thursday, October 13, the Julian date is 286, so Delta is 0.

When Delta reaches 0, the first IF statement (Delta==0) in pseudocode algorithm 700 becomes true, and the pseudocode algorithm configures out-of-office functionality (e.g., by generating an out-of-office message) and activates the out-of-office functionality. This is performed by calling functions entitled ConfigureOOF( ) and ActivateOOF( ) respectively.

Next, the pseudocode algorithm 700 checks whether the CurrentDate is equal to EndHoliday in the second IF statement. If not, the pseudocode algorithm continues to another iteration of the loop, updates the CurrentDate variable, and goes back to the first IF statement. On Friday, October 14, the Julian date is 287, so Delta is −1 and the first IF statement evaluates to false. Similarly, on Saturday, October 15, the Julian date is 288, Delta is −2, and the first IF statement evaluates to false.

Likewise, on October 14 and 15 the second IF statement also evaluates to false. However, on Sunday, October 16, the first IF statement evaluates to false and the second IF statement evaluates to true. Thus, the pseudocode algorithm 700 enters the second IF statement and deactivates the out-of-office functionality. In addition, the HolidayCounter is increased by 1 so that the next time through the loop the next holiday will be used to set BeginHoliday and EndHoliday (e.g., perhaps a winter solstice holiday in December).

Note that alternative algorithmic implementations are contemplated. For example, some implementations may initialize an additional counter to 0 and calculate the number of days until the next holiday. Then, the additional counter can be incremented each day until the additional counter equals the number of days until the next holiday. At this time, out-of-office processing can be performed as discussed elsewhere herein. Then, the additional counter can be set back to 0, the number of days until the next holiday can be determined again, and so on.

Also, note that the aforementioned algorithms do not explicitly account for the time of day. In further implementations, the out-of-office processing can be initiated the day before a holiday. The aforementioned algorithms can be augmented in various ways to account for this. For example, referring back to FIG. 7, the CurrentDate variable can be incremented by one after a specified time of day, e.g., 5:30 PM. Thus, while Wednesday, October 12, has a Julian date of 285, this can be incremented at 5:30 PM to effectively treat all times after 5:30 PM as occurring the next day, on the Harvest Holiday. As a consequence, the user's out-of-office functionality will be initiated after their normal work hours on the evening before the Harvest Holiday. This can be useful because the user may receive an email that evening from another user (e.g., at 7:30 PM) and the another user will receive an out-of-office message indicating they should not expect to hear back until Monday.

### Further Implementations

Generally, the examples discussed above relate to user applications that provide email and/or calendar functionality. However, the disclosed implementations are readily extensible to other technologies, such as chat/instant messaging, text or multimedia messaging (short message service or “SMS” and multimedia message service or “MMS”), etc.

In addition, some implementations may use a synchronized feed to implement out-of-office functionality. For example, each user device in FIG. 5 or peer device in FIG. 6 may subscribe to an RSS (“Really Simple Syndication”) or Atom feed that synchronizes email messages, calendar entries, etc., across the various devices. When a holiday occurs for a given user, the out-of-office module 118 on that user's device can update the feed to indicate that the user will be out-of-office during the holiday.

In further implementations, some users may be located in different areas that have different out-of-office events. For example, referring back to FIG. 3, Dennis may live in a country that has the Harvest Festival from October 13-16. Jane may live in another country that does not celebrate the Harvest Festival, but that celebrates a Winter Festival later in the year, e.g., December 8-11.

In this example, refer back to FIG. 5 and let Dennis operate user device 510 and Jane operate user device 520. The out-of-office module 118(5) on cloud server 550 can obtain location information for both Dennis and Jane. Given the location information, the cloud server can access a local or remote source of out-of-office events for the respective countries of Dennis and Jane. Thus, the out-of-office module can automatically activate out-of-office functionality for Dennis between October 13-16, and for Jane between December 8-11.

Note also that the out-of-office module 118(5) can automatically determine information other than the out-of-office dates to include in an out-of-office message. For example, the out-of-office module may have access to local or remote databases indicating that Jane and Dennis work in the same department of a company. Thus, the out-of-office module can surmise that Jane and Dennis could serve as emergency contacts when one or the other is not available. Accordingly, the out-of-office module can determine that Jane can serve as an emergency contact for Dennis during October 13-16, since her country does not have any designated out-of-office events during this time. Likewise, the out-of-office module can determine that Dennis can serve as an emergency contact for Jane during December 8-11, since his country does not have any out-of-office events during this time.

Once an out-of-office contact has been determined by the out-of-office module 118(5), the out-of-office module can autopopulate the out-of-office message with the name of the contact. In addition, the out-of-office module can access a local or remote database to obtain contact information for the designated contact (e.g., email address, phone number, etc.), and automatically populate the out-of-office message with the contact information.

Also, note that some implementations may distinguish between different types of contacts. For example, some users may have an address book with both personal and business contacts. When a user is designated as out-of-office for a holiday, the user may appear unavailable during that time to their business contacts. However, the user may appear as available during that time to their personal contacts. As another example, the out-of-office messages may be sent to business contacts, but not to personal contacts, in response to received invitations or emails that occur when the user is out of the office.

### Device Implementations

Referring back to FIG. 1, computing device 110 is shown in a tablet form factor. However, the disclosed implementations can be provided in any number of different types of computing devices, such as smartphones, tablets, laptops, desktops, etc. In addition, the disclosed implementations can be provided in wearable devices (e.g., a smart watch), augmented reality devices, etc. Other examples include computer-enabled home appliances, automobiles, whiteboards, televisions, etc. Generally, so long as a device has some computational hardware that can be configured to perform out-of-office processing, the disclosed implementations can be provided in such a device. The following discussion of computing device 110 is also applicable to devices 130, 140, and 150 in FIG. 1, devices 510, 520, 530, 540, and 550 in FIG. 5, and devices 610, 620, 630, and 640 in FIG. 6.

The term “device”, “computer,” “computing device,” “client device,” “server device,” “computer system,” “user device,” “peer device,” etc., as used herein can mean any type of device that has some amount of hardware processing capability and/or hardware storage/memory capability. Processing capability can be provided by one or more hardware processing units (e.g., hardware processing units/cores) that can execute computer-readable instructions to provide functionality. Example processing units shown herein include each instance of processing resources 112. Computer-readable instructions and/or data can be stored on memory/storage resources 114.

Memory/storage resources 114 can be internal or external to the computing device 110. The storage can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose processing unit and storage/memory. In other cases, a device can include a system on a chip (SOC) type design. In SOC design implementations, functionality provided by the device can be integrated on a single SOC or multiple coupled SOCs. One or more associated processing units can be configured to coordinate with shared resources, such as memory, storage, etc., and/or one or more dedicated resources, such as hardware blocks configured to perform certain specific functionality. Thus, the term “processor” or “processing component” as used herein can also refer to central processing units (CPUs), graphical processing units (GPUs), controllers, microcontrollers, processor cores, or other types of processing devices suitable for implementation both in conventional computing architectures as well as SOC designs.

Note also that user application 116, out-of-office module 118, compiler/interpreter 120, and scheduler 122 can also be implemented as various types of hardware. More generally, any of the components of computing device 110 and/or the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Also note that computing device 110 generally can have input and/or output functionality. For example, computing devices can have various input mechanisms such as keyboards, mice, touchpads, voice recognition (e.g., via a microphone), gesture recognition (e.g., using depth cameras such as stereoscopic or time-of-flight camera systems, infrared camera systems, RGB camera systems, or using accelerometers/gyroscopes, facial recognition, etc.). Devices can also have various output mechanisms such as printers, monitors, speakers, etc.

### Additional Examples

Various device examples are described above. Additional examples are described below. One example includes a method comprising the identifying of an out-of-office event that is scheduled to occur at a particular date, detecting that the out-of-office event has arrived, and responsive to detecting that the out-of-office event has arrived, automatically activating out-of-office functionality on a computing device associated with a user.

Another example can include any of the above and/or below examples where the automatically activating includes automatically populating a message with information about the out-of-office event and causing the message to be sent to another user.

Another example can include any of the above and/or below examples where the automatically populating comprises configuring the message with a start time or start date of the out-of-office event.

Another example can include any of the above and/or below examples where the automatically populating comprises configuring the message with both a start time or start date and an end time or end date of the out-of-office event.

Another example can include any of the above and/or below examples where the out-of-office event comprises a weekend followed by a holiday or a holiday followed by a weekend.

Another example can include any of the above and/or below examples where the automatically activating the out-of-office functionality comprises automatically configuring an electronic calendar of the user to reflect the out-of-office event.

Another example can include any of the above and/or below examples where the method further comprises sharing the electronic calendar of the user with another user.

Another example can include a computer system comprising a processor and a computer-readable storage medium storing instructions which, when executed by the processor, causes the processor to detect an out-of-office event for a user and automatically configure an out-of-office message for the user responsive to detecting the out-of-office event.

Another example can include any of the above and/or below examples where instructions from the computer system which, when executed by the processor, cause the processor to display a message indicating that the out-of-office message is being sent from the computer system to other computing systems in response to received messages.

Another example can include any of the above and/or below examples where the instructions, when executed by the processor, cause the processor to populate the out-of-office message with an alternative contact for the user and contact information for the alternative contact.

Another example can include any of the above and/or below examples where the instructions provide an email client configured for the user and a separate executable file that detects the out-of-office event and automatically configures the email client.

Another example can include any of the above and/or below examples where the computer system is embodied as a cloud server.

Another example can include any of the above and/or below examples where the instructions, when executed by the processor, cause the processor to send a message from the cloud server to a local email client on a user device of the user, the message instructing the local email client to activate out-of-office messages for the user.

Another example can include any of the above and/or below examples where the instructions, when executed by the processor, cause the processor to automatically configure the out-of-office message for multiple instances of an email application for multiple users of multiple different user devices.

Another example can include a computing device comprising a storage device storing an email application and a file having programming statements. The computing device further comprises a processor configured to execute the email application and the programming statements. The programming statements in the file are configured to, when executed by the processor, automatically detect out-of-office events and cause the email application to send out-of-office messages indicating that a user of the email application is out-of-office for the duration of the out-of-office events.

Another example can include any of the above and/or below examples where the file is a batch file, and the storage device further stores a compiler configured to convert the batch file to an executable file.

Another example can include any of the above and/or below examples where the storage device further comprises a scheduler configured to execute on the processor, where the scheduler is configured to run the executable file at specific times of day.

Another example can include any of the above and/or below examples where the storage device further comprises a scheduler configured to execute on the processor, where the scheduler is configured to run the executable file responsive to detecting that a user has logged off of the computing device.

Another example can include any of the above and/or below examples where the programming statements are configured to access a source of out-of-office data and automatically detect the out-of-office events using the source of out-of-office data.

Another example can include any of the above and/or below examples where the source of out-of-office data comprises a local text file stored on the computing device or a network resource located remotely from the computing device.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims, and other features and acts that would be recognized by one skilled in the art are intended to be within the scope of the claims.

1. A method comprising:
identifying an out-of-office event that is scheduled to occur at a particular date;
detecting that the out-of-office event has arrived; and
responsive to detecting that the out-of-office event has arrived, automatically activating out-of-office functionality on a computing device associated with a user.

2. The method of claim 1, the automatically activating the out-of-office functionality comprising:
automatically populating a message with information about the out-of-office event; and
causing the message to be sent to another user.

3. The method of claim 2, the automatically populating comprising:
configuring the message with a start time or start date of the out-of-office event.

4. The method of claim 2, the automatically populating comprising:
configuring the message with both a start time or start date and an end time or end date of the out-of-office event.

5. The method of claim 4, the out-of-office event comprising a weekend followed by a holiday or a holiday followed by a weekend.

6. The method of claim 1, the automatically activating the out-of-office functionality comprising:
automatically configuring an electronic calendar of the user to reflect the out-of-office event.

7. The method of claim 6, further comprising:
sharing the electronic calendar of the user with another user.

8. A computer system comprising:
a processor; and
a computer-readable storage medium storing instructions which, when executed by the processor, cause the processor to:
detect an out-of-office event for a user; and
automatically configure an out-of-office message for the user responsive to detecting the out-of-office event.

9. The computer system of claim 8, instructions which, when executed by the processor, cause the processor to:
display a message indicating that the out-of-office message is being sent from the computer system to other computing systems in response to received messages.

10. The computer system of claim 9, wherein the instructions, when executed by the processor, cause the processor to:
populate the out-of-office message with an alternative contact for the user and contact information for the alternative contact.

11. The computer system of claim 10, the instructions providing an email client configured for the user and a separate executable file that detects the out-of-office event and automatically configures the email client.

12. The computer system of claim 10, embodied as a cloud server.

13. The computer system of claim 12, wherein the instructions, when executed by the processor, cause the processor to:
send a message from the cloud server to a local email client on a user device of the user, the message instructing the local email client to activate out-of-office messages for the user.

14. The computer system of claim 13, wherein the instructions, when executed by the processor, cause the processor to:
automatically configure the out-of-office message for multiple instances of an email application for multiple users of multiple different user devices.

15. A computing device comprising:
a storage device storing an email application and a file having programming statements; and
a processor configured to execute the email application and the programming statements,
the programming statements in the file being configured to, when executed by the processor:
automatically detect out-of-office events; and
cause the email application to send out-of-office messages indicating that a user of the email application is out-of-office for the duration of the out-of-office events.

16. The computing device of claim 15, the file being a batch file, the storage device further storing a compiler configured to convert the batch file to an executable file.

17. The computing device of claim 16, the storage device further comprising a scheduler configured to execute on the processor, wherein the scheduler is configured to:
run the executable file at specific times of day.

18. The computing device of claim 16, the storage device further comprising a scheduler configured to execute on the processor, wherein the scheduler is configured to:
run the executable file responsive to detecting that a user has logged off of the computing device.

19. The computing device of claim 16, wherein the programming statements are configured to:
access a source of out-of-office data; and
automatically detect the out-of-office events using the source of out-of-office data.

20. The computing device of claim 19, the source of out-of-office data comprising a local text file stored on the computing device or a network resource located remotely from the computing device.
